(19) United States
(12) Patent Application Publication
(10) Pub. No.: US 2014/0326520 A1
(43) Pub. Date: Nov. 6, 2014

(54) KINETIC POWER SYSTEM FOR VEHICLES

(71) Applicant: Emery C. Stewart, JR., The Villages, FL (US)

(72) Inventor: Emery C. Stewart, JR., The Villages, FL (US)

(21) Appl. No.: 13/875,103

(22) Filed: May 1, 2013

(51) Int. Cl. B60K 16/00

(52) U.S. Cl. CPC B60K 16/00; B60K 2016/003; B60K 2016/006
USPC 180/2.2

(57) ABSTRACT

A kinetic power system for DC motor-driven vehicles, the system comprising a chassis-based power generating assembly and an optional roof-based power generating assembly, the former being in electrical communication with the vehicle's DC motor(s) and battery array, the latter being in electrical communication with the battery array only. Both assemblies include at least one fan blade rotatably mounted to a rotor shaft of a DC generator. The fan blades turn under the influence of air velocity provided by the wind and/or via motion of the vehicle (kinetic energy) to drive the generator(s) and produce an electric current which is then delivered either directly to the DC motor or indirectly to the battery array via an onboard inverter which converts the direct current to alternating current. Embodiments including photovoltaic cells are also described.

### RELATED APPLICATION

This application claims the benefit of U.S. Provisional Application No. 61/640,092 filed May 1, 2012 and entitled, Kinetic Power System for Vehicles.

### FIELD OF THE INVENTION

The present invention pertains to power systems for electric vehicles and, more particularly, to wind and/or vehicle movement driven generators electrically connected to the vehicle's DC motor(s) for delivery of direct current in real time.

### BACKGROUND OF THE INVENTION

The internal combustion engine is approximately 110 years old and appears to be at its zenith, having run its course for fuel economy; improved, but still much to be achieved. A primary obstacle to widespread acceptance of electrically powered vehicles has been their limited mileage range, it being desired to have a mileage range as great as possible to permit use of the vehicle as much as is possible. In addition to their limited range, prior art electrically powered vehicles have the disadvantage of requiring much down-time for recharging of the batteries, such recharging normally being accomplished overnight by connecting the batteries with available residential or commercial sources of electricity. Some electric vehicles are teamed with small internal combustion engines, these offer some extra power but are still noisy, smelly, unhealthy, a poor option to the motoring public. It is indisputable that there exists a need for a clean, safe, efficient and healthy alternative to the antiquated pollution plagued internal combustion engine of the 19^{th} century, especially as it relates to light vehicles.

All patents, patent applications, provisional applications, and publications referred to or cited herein, or from which a claim for benefit of priority has been made, are incorporated herein by reference in their entirety to the extent they are not inconsistent with the explicit teachings of this specification.

### SUMMARY OF THE INVENTION

According to one aspect of the present invention, there is provided a kinetic power system for DC motor driven vehicles, the system comprising a chassis-based power generating assembly and an optional roof-based power generating assembly, the former being in electrical communication with the vehicle's DC motor(s) and battery array, the latter being in electrical communication with the battery array only. Both assemblies include at least one fan blade rotatably mounted to a rotor shaft of a DC generator. The fan blades turn under the influence of air velocity provided by the wind and/or via motion of the vehicle (kinetic energy) to drive the generator(s) and produce an electric current which is then delivered directly to the DC motor or indirectly to the battery array via an onboard inverter which converts the direct current to alternating current. Other embodiments of the present invention further include a rear glass canopy comprised of at least one photovoltaic panel which in turn is comprised of a plurality of photovoltaic cells for converting light energy (photons) into electricity through the photovoltaic effect.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a primary object of the subject invention to provide a kinetic power system for DC motor driven vehicles, wherein the system converts kinetic energy created by the wind and/or by movement of the vehicle into electric energy for delivery to at least one DC electric motor to power the vehicle.

It is also a primary object of the subject invention to provide a kinetic power system for the onboard recharging of batteries found in an electrically powered vehicle, or hybrid type vehicle, wherein the system converts kinetic energy created by the wind and/or by movement of the vehicle into electric energy for recharging of the batteries.

Another object of the present invention is to provide an onboard electrical re-charging system for vehicle batteries wherein the system includes at least one of a chassis-mounted power generating assembly and a roof-based power generating assembly, each including a fan blade rotatably mounted to a rotor shaft of at least one DC generator, wherein the fan blades turn under the influence of air velocity to drive the generator(s) and produce an electric current.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of the chassis-based and roof-based power generating assemblies of a preferred embodiment of the subject kinetic power system as installed in a motor vehicle;

FIG. 2 is a side elevation view of the vehicle and kinetic power system of FIG. 1, portions of which are illustrated in phantom view to better depict the arrangement of components of the system;

FIG. 3 is a plan view of an example battery arrangement of the subject kinetic power system;

FIG. 4 is a front elevation view of the vehicle and kinetic power system of FIG. 1;

FIG. 5 is a rear elevation view of the vehicle and kinetic power system of FIG. 1;

FIG. 6 is a detailed side elevation view of the air intake assembly component of the chassis-based power generating assembly; and

FIG. 7 is an enlarged view of a portion of the air intake assembly of FIG. 6.

### DETAILED DESCRIPTION OF THE PREFERRED EMBODIMENT

It should be clearly understood at the outset that it is not the intent of this disclosure to reinvent the automobile but to offer a feasible alternative power source. All braking, steering, ride control passenger safety and comfort features are of established, normal and usual automobile construction as they apply to this disclosure. It should be further understood that like reference numerals are intended to identify the same structural elements, portions or surfaces consistently throughout the several drawings herein, as such elements, portions or surfaces may be further described or explained by the entire written specification, of which this detailed description is an integral part. Unless otherwise indicated, the drawings are intended to be read (e.g. cross-hatching, arrangement of parts, proportion, degree, etc.) together with the specification, and are to be considered a portion of the entire written description of this invention. As used in the following description, any reference to the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

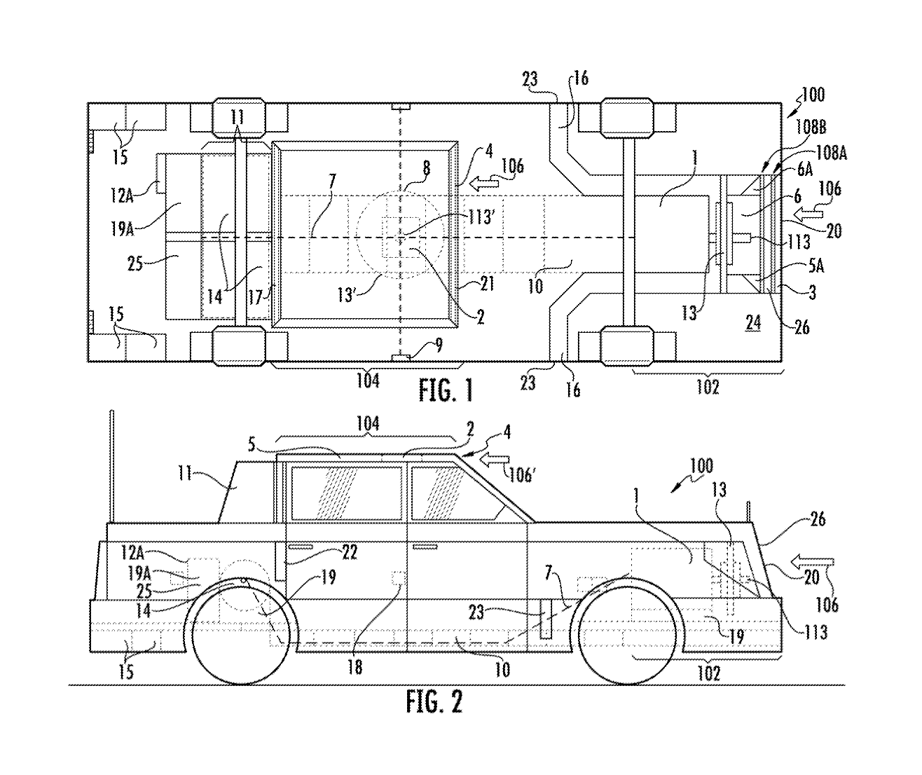

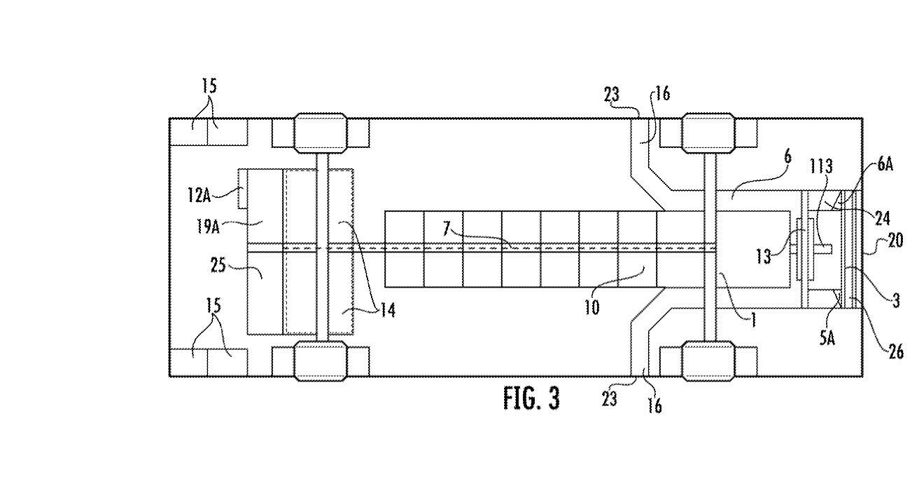

Reference is first made to FIGS. 1 and 2 in which there is illustrated plan and elevation views of a preferred embodiment of the subject kinetic power system (hereinafter also referred to more simply as “power system” or “apparatus”) as installed in a motor vehicle designated generally by reference numeral 100. Vehicle 100 is of the DC motor-driven type with the motor(s) being standard manufactured components, sized to compliment vehicle weight, size, intended purpose and requisite horsepower. Each motor is preferably, but not essentially, of a three phase induction type with thermal overload relays, and is cooled by air drawn into intake vents 22, passing through the motor compartment and exiting through rear vents 22′ (FIG. 5). In one embodiment, vehicle 100 includes a motor compartment located forward of the trunk compartment, the former housing two 90 HP DC electric motors 14 in, each in operable communication with a rear wheel, and together capable of producing a total of 134 KW of energy and approximately 130 foot pounds of torque per wheel (total torque approximately 262 ft.lbs.). Motors 14 may be mounted to the vehicle chassis via neoprene electric motor mounts 19. DC motors 14 are, when necessary, powered by battery array 10 as best observed upon reference to FIG. 3. Battery array 10 is comprised of a plurality of lightweight lithium batteries which can be charged from any external source of electricity. To this end, vehicle 100 will further include a socket or plug for connectivity to either the U.S. standard 110 volt or European standard 240 volt AC service supply. A variety of plugs and sockets are available for this purpose as the industry moves towards standardization. In the instant example, twenty (20) 12-volt lithium batteries are employed, including four (4) startup batteries 15 located in the trunk compartment and are electrically connected to an inverter 25 and rectifier 19A for DC to AC and AC to DC conversion, respectively. As may be appreciated on board startup batteries 15 are used for electric motor startup, as well as to power vehicle accessories, and may also be employed for travel power as and if required.

The subject kinetic power system is comprised of two primary components, namely a chassis-based power generating assembly 102 and a roof-based power generating assembly 104. Each are described in seriatim below.

With continued reference to FIGS. 1 and 2, chassis-based power generating assembly 102 is located in enclosure 6 of the hood compartment, generally forward of the vehicle's front axle, and is comprised of at least one fan 13 rotatably mounted to a rotor shaft 113 of first DC generator 1. The at least one fan is located behind an air intake assembly, described below, and receives an uninterrupted incoming flow of air, as indicated by directional arrow 106, against its blades when vehicle 100 is in motion. Air enters the air intake assembly, passes across fan 13, through ducts 16 and exits the vehicle via vents 23 to cool the system. As may be appreciated, fan 13 turns under the influence of air velocity provided by the wind and/or via forward motion of the vehicle to drive first DC generator 1 and produce an electric current. The current produced by first DC generator 1 is instantly delivered directly to DC motors 14 via insulated power cable 7. Control means, not shown, directs surplus DC power to inverter 25 for conversion to AC power and subsequent storage in battery array 10. By way of example, first DC generator 1 is a low friction, 67 KW, 89 horsepower DC generator having a two foot diameter fan 13.

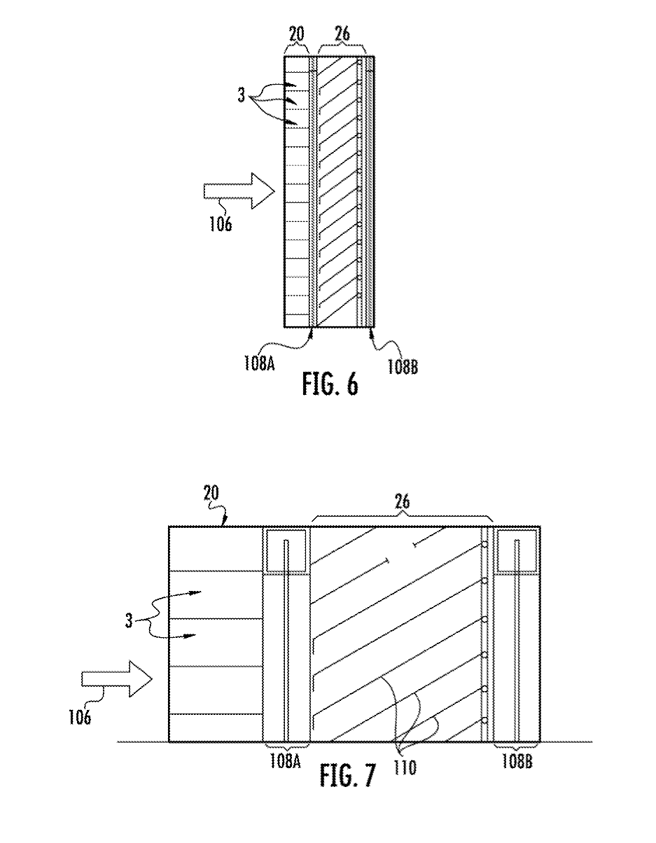

Referring now to FIGS. 6 and 7, an air intake assembly is situate forward of fan 13 and behind vehicle grille 20 for controlling the amount of air imparted onto the fan blades. As may be readily appreciated, grille 20 shields fan 13 from airborne dirt and debris which would otherwise enter air intake 3. Those skilled in the art will recognize that the greatest single factor that determines the amount of power available by the generator is wind velocity which is a function of wind direction relative to the vehicle's direction of travel, and of vehicle speed (i.e., P=½pAv³). Moreover, hot dry air contains less air molecules per a given volume than does cool damp air. Accordingly, the latter will cause fan 13 to rotate more rapidly thus causing first DC generator to generate more power comparatively speaking. Greater power transmitted to motors 14 results in greater vehicle speed. Depending on weather conditions and the desired speed of the vehicle, the volume of air entering air intake 3 may need to be increased or decreased. The louver panel 26 located behind air intake 3 accomplishes this function by affectively changing the size of the intake and thus acts as a weather tempering system.

More specifically, the air intake assembly is comprised of a pair of removable screens 108A,B, (i.e., filters) and an adjustable louver panel 26 therebetween comprised of a plurality of pivotable slats 110 which divide intake 3 into a plurality of smaller openings or portals. Slats 110 are angle adjustable by the vehicle operator (remotely from the vehicle's passenger cabin) to change the size of the portals (the space between each slat) which in turn controls the volume of air passing therethrough and thus vehicle speed; angles permitting greater air intake result in greater peed whereas angles permitting less air intake resulting in reduced speed. Those skilled in the art will recognize other constructions of airflow control means, such as a diaphragm for instance, the above louver panel being merely illustrative. Referring again to FIGS. 1 and 2, the air intake assembly further includes positive and negative air pressure sensors 5A and 6A, respectively, immediately behind second air filter 108B. Positive air pressure is required to operate fan 13 and first DC generator 1 in order to supply constant DC current to electric motors 14. Negative air pressure (“suction”) is a drafting affect of large trucks on open highways. Negative air pressure sensor 6A detects this condition and activates onboard batteries 10 to power motors 14 until the condition is resolved.

Roof-based power generating assembly 104 is alternately mounted within a housing 5 on top of the roof of vehicle 100 or is incorporated into the roof itself, and is comprised of at least one fan 13′ rotatably mounted to a vertical rotor shaft 113′ of second, roof-based) DC generator 2 which is of the low profile type. The at least one fan 13′ is located behind an air intake 4 and receives an uninterrupted incoming flow of air, as indicated by directional arrow 106′, against its blades when vehicle 100 is in motion. Air enters intake 4, passes across fan 13′. and exits through the rear of housing 5 via vents 17 to cool the system. Fan 13′ turns under the influence of air velocity provided by the wind and/or via forward motion of the vehicle to drive second DC generator 2 and produce an electric current. The current produced by second DC generator 2 is delivered directly to inverter 25 via insulated power cable 8 for conversion to AC power and subsequent storage in battery array 10. DC generator 2, inverter 25 and battery array 10 are electrically connected in series. Note that a portion of cable 8 passes through door stiles 9 located on each side of vehicle 100. As may be appreciated, air intake 4 may be adapted with an air intake assembly similar in construction to that described above including, but not limited to, a protective grille 21 and louver assembly (not shown). One or both air intake assemblies may further include heating and defrosting means as required.

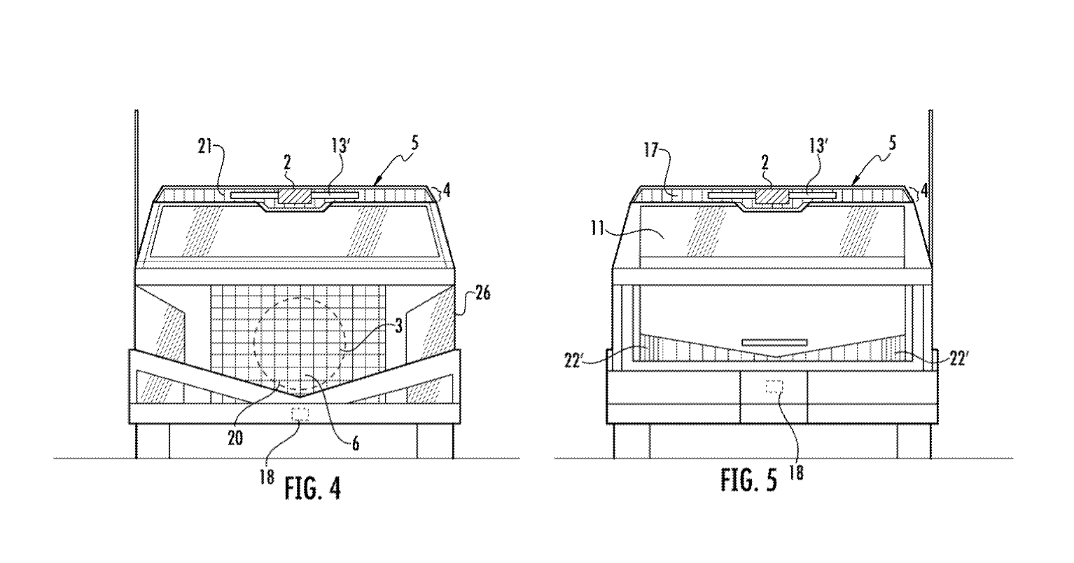

Reference now being made to FIGS. 1, 4 and 5, ancillary system components include a plurality of collision impact detectors strategically located about the vehicle's perimeter and designed to disconnect electrical power in the event of an accident. Referring to FIGS. 1, 2 and 5, vehicle 100 may further include a rear glass canopy 11 comprised of at least one photovoltaic panel which in turn is comprised of a plurality of photovoltaic cells for converting light energy (photons) into electricity through the photovoltaic effect. The photovoltaic cells are connected electrically to one another in series to achieve a desired output voltage and/or in parallel to provide a desired current capability, and each panel is electrically connected to inverter 25 for conversion to AC power and subsequent storage in battery array 10 or powering of vehicle accessories. In one embodiment, the photovoltaic panels employ wafer-based monocrystalline, polycrystalline or spheral cells made of a semiconductor material such as silicon treated with phosphorous and boron molecules to achieve a photoelectric effect and are laminated onto the glass. In another embodiment, thin-film cells comprised of materials selected from the group consisting of amorphous silicon, cadmium telluride and copper indium diselenide, are deposited on at least a portion of the outer surface of auto glass canopy 11 (typically tempered glass) with silane (a fluid silicon coupling agent). The thin-film cells may be manufactured with transparent strips between opaque or overly dark translucent surfaces allowing incident light to pass through and to afford greater visibility through the glass canopy 11. An example canopy 11 includes a 20 square foot collector panel with dark-tinted safety glass and capable of producing 10 watts of collected current per square foot yielding 200 watts of output to power vehicle accessories. Those skilled in the art will recognize other semiconductor materials and methods of application to the substrate and which are characterized by high-efficiency conversion at low cost. Moreover, it should be appreciated that a benefit of the above-described photovoltaic power systems is the fact that the vehicle's battery array can be at least partially recharged even when the vehicle is not being operated simply by parking it in a sunlit area.

The herein described kinetic power system is advanced beyond the available electric vehicles of today. With proper road conditions, open highway, normal weather, this system is virtually self-sustaining and will afford increased travel distances (i.e., range), with fewer vehicle stops for recharging of onboard batteries. Vehicle weight must be carefully controlled to compliment the anticipated power source performance. (i.e., P=½ pAv³ where P=Power, p=Air density, A=Area, and V=velocity).

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A kinetic power system for DC motor-driven vehicles having at least one DC motor mounted, to a chassis and powered by a battery array, a hood compartment, and a passenger compartment having a roof, the system comprising:
a. an air intake assembly mounted behind the vehicle's front grille for receiving a flow of air therethrough, said air intake assembly including airflow control means comprised of a louver panel having a plurality of angle adjustable slats for regulating the amount of airflow through said louver panel;
b. a chassis-based power generating assembly in electrical communication with the vehicle's at least one DC motor and battery array; said chassis-based power generating assembly comprising a DC generator mounted within the vehicle's hood compartment and behind said air intake assembly, said DC generator having a rotor shaft and at least one fan rotatably mounted thereto, said at least one fan being operably located behind said air intake assembly;
whereby said at least one fan turns under the influence of air velocity provided by the wind and/or via forward motion of the vehicle to drive said DC generator and produce an electric current deliverable directly to the vehicle's at least one DC motor and any surplus DC power to an inverter for conversion to AC power and subsequent storage in the battery array.

2. The kinetic power system of claim 1, further comprising:
a. a roof-based air intake assembly mounted on top of, or integrally formed with the vehicle roof for receiving a flow of air therethrough; and
b. a roof-based power generating assembly electrically connected in series to an inverter and then to the vehicle's battery array; said roof-based power generating assembly comprising a low profile DC generator mounted on top of, or integrally formed with the vehicle roof and behind said roof-based air intake assembly, said low profile DC generator having a rotor shaft and a fan rotatably mounted thereto;
whereby the current produced by said low profile DC generator is delivered directly to inverter for conversion to AC power which in turn is delivered to the battery array for recharging thereof.

3. The kinetic power system of claim 1, further comprising at least one photovoltaic panel for producing a direct current when exposed to sunlight, said at least one photovoltaic panel being electrically connected to said inverter for conversion of said direct current to AC power for recharging of said battery array and/or powering of vehicle accessories.

4. The kinetic power system of claim 2, further comprising at least one photovoltaic panel for producing a direct current when exposed to sunlight, said at least one photovoltaic panel being electrically connected to said inverter for conversion of said direct current to AC power for recharging of said battery array and/or powering of vehicle accessories.

5. The kinetic power system of claim 1, wherein said air intake assembly further includes at least one air pressure sensor behind said louver panel for detecting negative air pressure whereupon said battery array is caused to power said at least one DC motor until the condition is resolved.

6. The kinetic power system of claim 2, wherein said air intake assembly further includes at least one air pressure sensor behind said louver panel for detecting negative air pressure whereupon said battery array is caused to power said at least one DC motor until the condition is resolved.

7. The kinetic power system of claim 3, wherein said air intake assembly further includes at least one air pressure sensor behind said louver panel for detecting negative air pressure whereupon said battery array is caused to power said at least one DC motor until the condition is resolved.

8. The kinetic power system of claim 4, wherein said air intake assembly further includes at least one air pressure sensor behind said louver panel for detecting negative air pressure whereupon said battery array is caused to power said at least one DC motor until the condition is resolved.
